(19) United States
(12) Patent Application Publication
(10) Pub. No.: US 2005/0283319 A1
(43) Pub. Date: Dec. 22, 2005

(54) Method, system, and apparatus for detecting biological agents with a portable computing device

(75) Inventors: John L. Ferenczi, Cary, NC (US); William G. Barrus, Cary, NC (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, ARMONK, NY (US)

(21) Appl. No.: 10/869,353

(22) Filed: Jun. 16, 2004

(51) Int. Cl. G06F 19/00

(52) U.S. Cl. 702/20

(57) ABSTRACT

A system for detecting genetic patterns can include a bio-detector and an adapter configured to cooperatively engage the bio-detector. The system also can include a portable computing device being communicatively linked with the bio-detector via the adapter. The portable computing device can be programmed to interpret output from the bio-detector.

### BACKGROUND

1. Field of the Invention

The present invention relates to the analysis of genetic data using portable computing devices.

2. Description of the Related Art

A bio-detection mechanism typically includes a sampling platform and a transducer that translates chemical reactions into electrical signals. The sampling platform can include one or more cells or probes (collectively “probes”), commonly arranged as a collection of one or more arrays or microarrays. While a sampling platform can include one or more probes, a single microarray can include thousands of biological probes. Each probe can detect a particular biological agent or characteristic. When a sample is applied to the sampling platform, the occurrence of a chemical reaction at a probe indicates that the sample included the agent for which that probe was designed to detect. The reaction can be detected using some variety of transducer.

One variety of transducer can include a light source and an optical sensing mechanism. In that case, the sample usually is treated with an indicator that can exhibit fluorescence under particular circumstances. The occurrence of a reaction at a probe can be detected by subjecting that probe to light from the light source, thereby causing any probes experiencing a reaction with the sample to fluoresce. The fluorescence exhibited by probes can be detected using the optical sensing mechanism. The optical sensing mechanism can provide electrical signals as output which indicate the probes in which fluorescence was detected. As such, the electrical signals provide an indication as to which biological agents were detected.

Recent advances in biotechnology have allowed such bio-detection systems to be implemented as integrated circuits, commonly referred to as a biochips. Still, other implementations of bio-detection mechanisms can include biosensors. Common applications of biochips and biosensors can include genetic decoding, toxicology analysis, protein analysis, biochemical research, and the detection of chemical agents, particularly those associated with biological warfare.

Still, while bio-detection mechanisms have found their way into many different areas of research, these devices have not found widespread application, particularly with respect to medical diagnosis and treatment.

### SUMMARY OF THE INVENTION

In accordance with the inventive arrangements disclosed herein, a portable computing device can be used in conjunction with a bio-detection mechanism to identify biological materials, genetic materials such as deoxyribonucleic acid (DNA), ribonucleic acid (RNA), etc., and/or chemical materials (collectively “biological agents”). The portable computing device can be configured to identify detected biological agents by processing data received from a bio-detection mechanism. Supplemental information, for example information pertaining to detected biological agents and possible diagnoses, can be stored within the portable computing device and presented when such biological agents are detected. Notably, biological agent information and/or supplemental information also can be transmitted from the portable computing device to a remote information processing system.

One aspect of the present invention can include a system for detecting biological agents. The system can include a bio-detector and an adapter configured to cooperatively engage the bio-detector. The system also can include a portable computing device being communicatively linked with the bio-detector via the adapter. The portable computing device can be programmed to interpret output from the bio-detector.

Another aspect of the present invention can include a method of communicating biological agent-related data within a portable computing device. The method can include receiving, within the portable computing device, signals indicative of a detected biological agent. The detected biological agent can be compared with items of biological information stored within the portable computing device. One or more of the items of biological information that corresponds with the detected biological agent can be selected. Through the portable computing device, the selected item(s) of biological information can be presented.

Another aspect of the present invention can include a machine readable storage being programmed to cause a machine to perform the various steps disclosed herein.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating a system for detecting and processing biological information in accordance with one embodiment of the present invention.

FIG. 2 is a schematic diagram illustrating a system for detecting and processing biological information in accordance with another embodiment of the present invention.

FIG. 3 is a flow chart illustrating a method of detecting and processing biological information in accordance with yet another embodiment of the present invention.

### DETAILED DESCRIPTION OF THE INVENTION

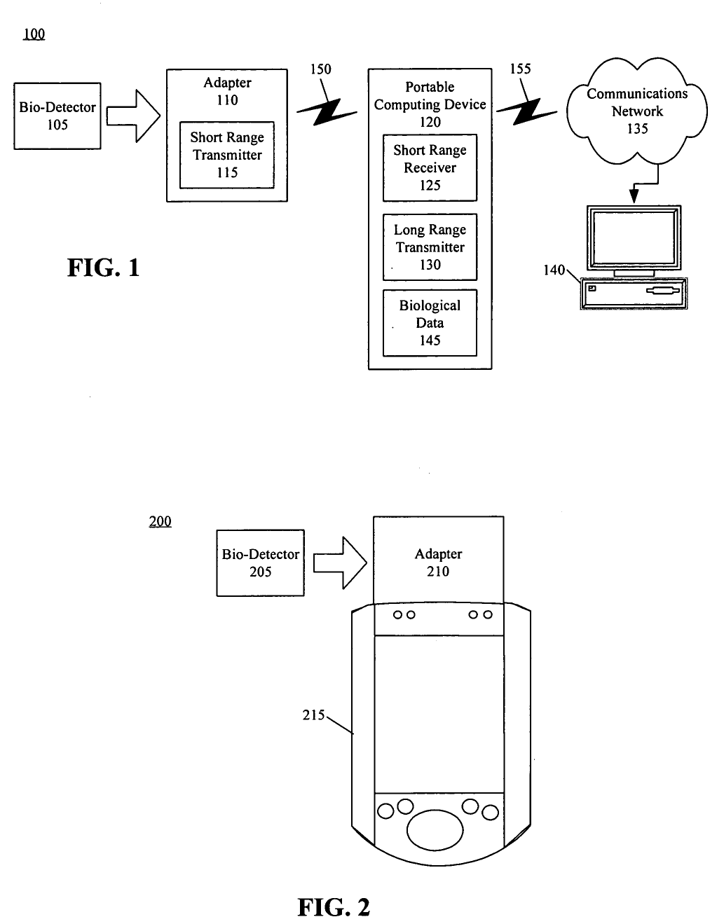

FIG. 1 is a schematic diagram illustrating a system 100 for detecting and processing biological, genetic, and/or chemical information (collectively “biological information”) in accordance with one embodiment of the present invention. As shown, the system 100 can include a bio-detector 105, an adapter module (adapter) 110, a portable computing device 120, a communications network 135, and a remote information processing system 140.

The bio-detector 105 can include one or more probes for detecting particular biological agents and/or characteristics. In one embodiment, the bio-detector 105 can include one or more arrays and/or microarrays. Still, in another embodiment, the bio-detector 105 can be implemented as a biosensor or as a biochip.

The bio-detector 105 can include a sampling platform and a transducer to detect reactions occurring between the probes and any sample applied thereto. The transducer further can translate those detected reactions into electronic signals. One example of a transducer can include a light source and optical sensing device or circuitry capable of detecting fluorescence exhibited by one or more probes of the bio-detector 105. In any case, the bio-detector 105 can detect biological agents within a given sample and provide one or more electrical signals indicative of the detected biological agents as output which can be further processed.

The adapter 110 can be fashioned to cooperatively engage the bio-detector 105. Once engaged, the adapter 110 and the bio-detector 105 can be in physical contact with one another and communicatively linked via an electrical connection. The adapter 110 can include a short range transmitter 115 capable of establishing and maintaining a wireless communication link 150 with a nearby a receiver, such as the portable computing device 120. For example, in one embodiment, the short range transmitter 115 can be a Blue-Tooth enabled wireless transmitter or any other transmitter capable of communicating over a similar short range wireless communication link.

While the adapter 110 is depicted as including the short range transmitter 115, it should be appreciated that the adapter 110 can include a short range wireless transceiver in place of the transmitter, thereby allowing the adapter to both send and receive information.

In another embodiment, the adapter 110 can include an optical sensing mechanism to detect fluorescence from the bio-detector 105. Such an embodiment can be useful in cases where the bio-detector 105 is not a self-contained processing system, but rather a combination of one or more arrays and/or one or more microarrays. In that case, the adapter 110 can detect fluorescence exhibited by the bio-detector 105. Optical circuits within the adapter 110 can translate the detected fluorescence into electrical signals, which can be transmitted to the portable computing device 120 via the wireless communication link 150.

The portable computing device 120 can be a hand-held computing device such as a personal digital assistant or other device having a form factor that allows a user to easily carry the device on his or her person. For example, the portable computing device 120 can be a device capable of executing the PALM OS, WINDOWS CE, or other similar operating system. As shown, the portable computing device 120 can include a short range receiver 125 capable of receiving wireless communications from the adapter 110. For example, the short range receiver 125 can be a Bluetooth enabled receiver or a receiver capable of receiving wireless communications over any of a variety of short range wireless communication links. Similar to the adapter 110, the portable computing device 120 can include a short range transceiver rather than the short range receiver 125, thereby allowing the portable computing device to both send and receive data over the short range wireless communication link 150.

The portable computing device 120 also can include a long range transmitter 130, or a transceiver to send and receive data. The long range transmitter 130 can establish and maintain a wireless communication link 155 in accordance with any of a variety of communications protocols. In one embodiment, the long range transmitter 130 can be an 802.xx compliant transmitter capable of transmitting information wirelessly using any one of the 802 family of wireless communications protocols. In another embodiment, the long range transmitter 130 can be capable of establishing a wireless Internet connection, for example using Wireless Application Protocol, or another protocol that facilitates Internet communications via a hand-held or mobile communications device.

Accordingly, the portable computing device 120 can communicate with the remote information processing system 140 via the communications network 135. The remote information processing system 140 can be any of a variety of computer systems, whether portables, desktops, servers, or the like. The communications network 135 can include the Internet, mobile and/or cellular networks, wide area networks, local area networks, the Public Switched Telephone Network, and the like.

The portable computing device 125 further can access biological data 145, which can be stored in a memory within, or connected to, the portable computing device 125. The biological data 145 can specify descriptive information pertaining to a range of biological agents that can be detected by the bio-detector 105. The descriptive information can provide information relating to each biological agent, including one or more possible diagnoses that can be matched or correlated with the various biological agents that can be detected by the bio-detector 105.

In operation, a sample can be applied to the bio-detector 105 which can be inserted into the adapter 110. The adapter 110 can receive one or more signals from the bio-detector 105 indicating any biological agents identified within the applied sample. The adapter 110 can provide the signals received from the bio-detector 105 to the short range transmitter 115 to wirelessly transmit those signals to the portable computing device 120 via the wireless communication link 150.

Notably, in the case where the adapter 110 includes a transducer, such as an optical sensing device, and the bio-detector 105 includes only arrays and/or microarrays, the adapter 110 can read the bio-detector 105, generate electrical signals, and transmit those signals to the portable computing device 120.

The portable computing device 120, can receive the signals through the short range receiver 125. The portable computing device 120 can be programmed to correlate or match the data indicating the detected biological agents with the biological data 145. Any information pertaining to the detected biological agents, including diagnoses, can be presented, for example upon the display of the portable computing device 120.

The portable computing device 120 further can transmit any data, whether information indicating the detected biological agents or information extracted from the biological data 145, including diagnoses, over the wireless communications link 155 and the communications network 135, to the remote information processing system 140.

The system 100 can be used in a variety of different contexts to provide advance notice to third parties of detected biological agents or patient diagnoses. For example, the system 100 can be used by first responders to detect harmful biological agents. In another example, the system 100 can be used by first responders to diagnose a patient, and transmit results to a hospital before the patient arrives to facilitate more efficient treatment.

In one embodiment, first responders can collect a sample and place the sample into the bio-detector 105. The bio-detector 105 can be placed in the adapter 110. The adapter 110, for example, can be located within an information processing system disposed within the first responder vehicle. Results from the adapter 110 can be transmitted to the portable computing device 120 which can be carried by a first responder in the field. The portable computing device 120 can provide an indication and/or information, for example a diagnosis, pertaining to the cause of a problem with an individual or environment.

Further, it should be appreciated that the inventive arrangements disclosed herein can be used to detect foreign biological agents, whether introduced into the environment or a human and/or animal host. Any of a variety of biological agents can be detected, such that the inventive arrangements disclosed herein are not limited to analyzing DNA and/or RNA, but rather can detect foreign and/or disease causing biological agents within various hosts.

FIG. 2 is a schematic diagram illustrating a system 200 for detecting and processing biological information in accordance with another embodiment of the present invention. The system 200 can include a bio-detector 205, an adapter 210, and a portable computing device 215.

The system 200 can function in a manner that is substantially similar to that of system 100. Thus, portable computing device 215 can be configured to communicate with a remote information processing system via a wireless communication link. The adapter 210, however, as shown, can be fashioned to cooperatively engage the portable computing device 215. For example, the adapter 210 can be configured to be inserted into a communication port, a card slot, or other media port of the portable computing device 215. Accordingly, the adapter 210 need not include a wireless transmitter or transceiver, but instead serve as an interface between the bio-detector 205 and the portable computing device 215.

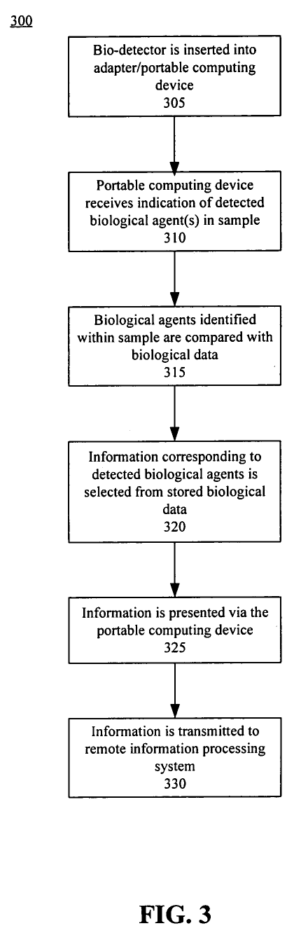

FIG. 3 is a flow chart illustrating a method 300 of detecting and processing biological information in accordance with yet another embodiment of the present invention. The method 300 can begin in a state where a sample, whether solid, gaseous, or liquid, has been applied to the bio-detector. Thus, for example, blood or any of a variety of other substances can be applied. Notably, while direct application of a sample can be performed, it should be appreciated that if the bio-detector is configured to detect airborne biological agents or gaseous samples, the sample can be the air or environment within which the bio-detector is disposed. In that case, a user or technician need not directly apply a sample to be analyzed.

Accordingly, in step 305, the bio-detector can be inserted into the adapter. If the adapter is configured to cooperatively engage the portable computing device, the adapter can be inserted into the portable computing device. For embodiments where the adapter is incorporated within the portable computing device, the bio-detector can be inserted directly into the portable computing device. If the adapter is distinct from the portable computing device, the adapter can establish a wireless communications link with the portable computing device.

In step 310, the bio-detector, after reacting with the sample, can output one or more electronic signals indicative of the biological agents detected within the sample. As noted, electronic signals from the bio-detector can be read by the portable computing device using the adapter as a conduit. Thus, the signals can be received by the portable computing device via a direct electronic link when the adapter is incorporated within or cooperatively engaged with the portable computing device. If the adapter is a distinct component, the signals can be received by the portable computing device via a wireless communication link.

As noted, however, in the case where the bio-detector is not a self-contained analysis system, the bio-detector can be read by the adapter, having a suitable transducer. In that case, signals generated by the transducer can be provided to the portable computing device via a wireless communication link.

Regardless, the output from the bio-detector and/or adapter indicates which biological agents were detected within the sample. The portable computing device can be programmed to identify which biological agents were detected from the received signals. For example, the biological data stored within the portable computing device can specify how to decode signals received from the bio-detector and identify the detected biological agents.

In step 315, the biological agents detected by the bio-detector can be compared with the biological data stored within the portable computing device. The portable computing device can compare the detected biological agents with the biological data to determine whether a match exists or whether any biological data corresponds with the detected biological agents.

In step 320, information pertaining to the detected biological agent(s) can be selected from the biological data stored with the portable computing device. The selected biological information can include, but is not limited to, descriptive information pertaining to the detected biological agents, potential diagnoses relating to the detected biological agents, and courses of treatment for the detected biological agents. The portable computing device also can be programmed to evaluate cases where more than one biological agent is detected and render a diagnosis, course of treatment, and/or provide any supplemental information depending upon the particular combination of biological agents detected.

In step 325, the selected biological information can be retrieved and then presented through the portable computing device. For example, the biological information can be displayed upon a display screen of the portable computing device or played through a text-to-speech processor, if the device is so enabled. By providing information in this manner, first responders can more effectively render treatment to persons, take remedial action, and/or contain a potentially dangerous situation.

In step 330, the biological information retrieved by the portable computing device can be forwarded to a remote information processing system via a wireless communication link. This enables useful information about detected biological agents to be forwarded from first responders to proper authorities, whether medical personnel at a hospital, disease control facilities, response units, and the like. Accordingly, critical personnel, such as medical workers, pharmacists, epidemiologists, and the like, can receive advance notice that persons requiring medical care will be arriving, thereby allowing the personnel to prepare and ready any needed treatments and/or equipment.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A system for detecting genetic patterns comprising:
a bio-detector;
an adapter configured to cooperatively engage the bio-detector; and
a portable computing device being communicatively linked with said bio-detector via said adapter, wherein said portable computing device is programmed to interpret output from said bio-detector.

2. The system of claim 1, wherein the bio-detector includes at least one microarray.

3. The system of claim 1, wherein said adapter is an attachment to said portable computing device such that said portable computing device cooperatively engages said adapter.

4. The system of claim 1, wherein said adapter is integrated within said portable computing device.

5. The system of claim 1, wherein said adapter is physically distinct from said portable computing device, and wherein said adapter is communicatively linked with the portable computing device via a wireless communications link.

6. The system of claim 5, said adapter further comprising an optical sensing mechanism to detect fluorescence from said bio-detector.

7. The system of claim 1, said portable computing device being configured to communicate output from said bio-detector to a remote information processing system.

8. The system of claim 1, said portable computing device further comprising items of descriptive information for biological agents detectable by said bio-detector, said portable computing device being configured to select at least one of the items of descriptive information corresponding with the output from said bio-detector.

9. The system of claim 8, said portable computing device, being configured to communicate the selected at least one item of descriptive information to a remote information processing system.

10. Within a portable computing device, a method of communicating biological agent-related data comprising:
receiving, within the portable computing device, signals indicative of a detected biological agent;
comparing the detected biological agent with items of biological information stored within the portable computing device;
selecting at least one of the items of biological information that corresponds with the detected biological agent; and
presenting, via the portable computing device, the selected at least one item of biological information.

11. The method of claim 10, further comprising communicating the selected at least one item of biological information to a remote information processing system.

12. The method of claim 11, said communicating step wirelessly communicating the selected at least one item of biological information.

13. A machine readable storage, having stored thereon a computer program having a plurality of code sections executable by a portable computing device for causing the portable computing device to perform the steps of:
receiving, within the portable computing device, signals indicative of a detected biological agent;
comparing the detected biological agent with items of biological information stored within the portable computing device;
selecting at least one of the items of biological information that corresponds with the detected biological agent; and
presenting, via the portable computing device, the selected at least one item of biological information.

14. The machine readable storage of claim 13, further comprising communicating the selected at least one item of biological information to a remote information processing system.

15. The machine readable storage of claim 14, said communicating step wirelessly communicating the selected at least one item of biological information.
